(19) United States
(12) Patent Application Publication
(10) Pub. No.: US 2024/0313323 A1
(43) Pub. Date: Sep. 19, 2024

(54) MOTOR VEHICLE WITH A HIGH VOLTAGE BATTERY

(71) Applicant: MAGNA STEYR Fahrzeugtechnik GmbH & Co KG, Graz (AT)

(72) Inventors: Bernhard HOFER, Graz (AT); Werner SCHWARZL, Laßnitzhoehe (AT)

(73) Assignee: MAGNA STEYR Fahrzeugtechnik GmbH & Co KG, Graz (AT)

(21) Appl. No.: 18/439,188

(22) Filed: Feb. 12, 2024

(30) Foreign Application Priority Data
Mar. 13, 2023 (EP) 23161462.9

(51) Int. Cl. H01M 50/249; H01M 10/613; H01M 50/264; H01M 50/271

(52) U.S. Cl. CPC H01M 50/249; H01M 50/264; H01M 50/271; H01M 10/613; H01M 2220/20

(57) ABSTRACT

A motor vehicle having a high-voltage battery. The high-voltage battery has a battery housing with a trough defined at least by sidewalls and a cover to cover the trough at an upper region of the sidewalls, and a plurality of battery cells mounted for suspension in the trough such that electrical contacts of the battery cells are oriented downwards and bases of the battery cells are oriented upwards.

### CROSS-REFERENCE TO RELATED APPLICATIONS

The present application claims priority under 35 U.S.C. § 119 to European Patent Publication No. EP 23161462.9 (filed on Mar. 13, 2023), which is hereby incorporated by reference in its complete entirety.

### TECHNICAL FIELD

The present disclosure relates to a motor vehicle having a high-voltage battery and to a method for producing such a motor vehicle.

### BACKGROUND

It is known that closed high-voltage batteries can be installed in motor vehicles, in particular as the drive battery for providing electrical energy for driving the motor vehicle. The battery then has a closed battery case, or a closed battery housing, which accommodates the cell modules. Such a high-voltage battery is fastened to the vehicle by means of screws. Apart from at the screw points, there is usually a gap of at least several millimetres between the battery and the vehicle structure, in order that rubbing is avoided during operation (noise, corrosion . . . ), but also in order to permit collision-free assembly. The entire battery unit must be dismounted from the vehicle for maintenance or repair.

Battery cells in their installed position usually have electrical contacts at their upper end for collecting the voltage and a cell base at their lower end. Battery cells damaged in an accident, for example, can then outgas upwards via the electrical contacts, in the direction towards the vehicle interior, and develop heat there.

### SUMMARY

It is an object of the present disclosure to provide a motor vehicle having a high-voltage battery which avoids the problems described above, has a low installation space requirement and contributes towards improved vehicle safety. A further object is to provide a simple and inexpensive method for producing such a motor vehicle.

The object is achieved by a motor vehicle having a high-voltage battery, wherein the high-voltage battery comprises a battery housing, wherein the battery housing comprises at least sidewalls and a cover which covers the sidewalls at the top, wherein a plurality of battery cells are arranged in the battery housing, wherein the sidewalls and the cover are formed in one piece by a trough which is open at the bottom and the battery cells are mounted “suspended” in the trough so that the electrical contacts of the battery cells are oriented downwards and the cell bases are oriented upwards.

In accordance with the present disclosure, a high-voltage battery with suspended cells is integrated in a motor vehicle. The cells are “inverted.” Meaning, the contacts of the battery cells face downwards, thus, towards the road in the installed position in the motor vehicle, and the cell bases are formed at the top of the battery cells. Any outgassing of the cells takes place in the region of the now downwardly directed cell contacts, that is to say downwards. Any heat development is now oriented in the direction of the underride guard/vehicle exterior and not, as is otherwise the case, in the direction towards the vehicle interior.

The high-voltage battery additionally has a battery housing which, in contrast to the conventional designs, does not use separate lateral housing or frame components or a separate cover but instead uses a trough which forms the sidewalls and the cover, which is at the top in the installed position in the motor vehicle, of the battery housing. This inverted trough can simply and inexpensively be fitted with further battery components, such as in particular battery cells, and installed in a structurally integrated manner in the vehicle body. The trough can at the same time close the underbody at the bottom. The trough can terminate directly at the floor panel of the motor vehicle and/or can form the floor panel in some regions, for example. A fundamental advantage of this solution is the installation space gained in the Z-direction, because the air gap which must usually be maintained between the battery cover and the floor panel can be omitted here. Dispensing with separate components, such as a separate battery cover or separate side parts or frame components, can also constitute a cost and weight advantage.

Developments of the present disclosure are indicated in the dependent claims, the description and the accompanying drawings.

Preferably, the cover of the trough forms a floor panel of the motor vehicle and/or the cover of the trough is fastened, in particular screwed and/or adhesively bonded, to a floor panel from beneath. The cover of the trough can form the floor panel in some regions, for example, and in other regions, in particular at edges, can be joined to a floor panel, for example.

The cover of the trough can have fastening points for seat cross-members. Seat cross-members are preferably fastened to the trough, in particular adhesively bonded and/or screwed to the cover of the trough.

Preferably, the trough is mounted, preferably adhesively bonded and screwed, to another supporting structure of the motor vehicle from beneath, preferably to lateral sills of the motor vehicle. The sill can be produced, for example, in a shell construction. The trough can then be joined to one or more shells of the sill, in each case preferably adhesively bonded and/or screwed.

The trough, in particular sidewalls of the trough, can form part of the supporting structure of the motor vehicle, preferably of the lateral sills of the motor vehicle. For example, a shell of the sill can be formed by a side wall of the trough.

Preferably, an underride guard plate forms the base of the high-voltage battery, which covers the trough on the lower side thereof. Accessibility to the battery cells can be ensured from beneath, via a preferably dismountable plate which at the same time serves as an underride guard.

Preferably, a plurality of cross-members of the supporting structure of the motor vehicle are arranged inside the trough of the high-voltage battery. Preferably, the cross-members are welded to sidewalls and/or to the cover of the trough. The cross-members thus preferably form a welded structure with the trough. In another preferred embodiment, the cross-members are formed integrally with the trough. Preferably, the trough is formed together with the cross-members as a die-cast component.

Preferably, the battery cells are each mounted “suspended” from the cross-members in the gaps between the cross-members, so that a plurality of parallel rows of battery cells run between the cross-members.

The battery cells can be mounted in the trough individually or can be mounted in the trough combined to form battery cell modules. The high-voltage battery can thus have battery modules mounted in a suspended manner.

Preferably, the trough of the high-voltage battery is sealed with respect to the floor panel by means of a removable seal, in particular a mounting seal.

Preferably, at least one planar cooling element, in particular at least one cooling plate, and/or at least one planar fire protection element is arranged on the upper side of the battery cells, between the battery cells and the cover of the trough. The cooling element or elements and the fire protection element or elements can be inserted and fixed above the cells.

A method in accordance with to the present disclosure for producing a motor vehicle as described hereinbefore can provide that the trough is produced together with the cross-members as a die-cast component, in particular by a so-called “megacasting” process, so that the cross-members are already integrated in the trough when the trough is produced. The trough can then be fitted with the battery cells outside the motor vehicle.

A method in accordance with the present disclosure for producing a motor vehicle as described hereinbefore can provide that the battery cells are mounted in the trough in a pre-assembly process, in order to produce the high-voltage battery, and then the pre-assembled high-voltage battery is mounted from beneath in another supporting structure of the motor vehicle, preferably is fastened to lateral sills of the motor vehicle.

At least one planar cooling element, that is to say a cooling plate, can be installed, for example inserted, in the trough, preferably from beneath, before the battery cells are mounted in the trough. The battery cells are then mounted in the trough. The battery cells can then be connected.

Pre-assembly of the battery housing takes place in the disassembled state, outside the motor vehicle that is to be produced, and the trough is readily accessible from beneath. The trough can also be inverted during the pre-assembly, so that fitting can take place from above. The cooling plate is preferably installed and fixed first. There then follow the battery cells, which can then be electrically connected to one another.

The pre-assembled battery, fitted with a protective cover, can be brought to an assembly line and installed in the vehicle from beneath by means of conventional handling apparatuses.

The pre-assembled high-voltage battery can be mounted from beneath in another supporting structure of the motor vehicle, preferably fastened, for example screwed, to lateral sills of the motor vehicle.

A lower closing plate, which can at the same time be designed as an underride guard, can be fastened to the trough at the end of the pre-assembly or fastened to the supporting structure and/or to the trough after the trough has been mounted on the supporting structure.

### DRAWINGS

The present disclosure will be illustrated by way of example in the drawings and explained in the description hereinbelow.

FIG. 1 is a sectional view of a part-region of a motor vehicle in the transverse direction of the vehicle (X-section), in accordance with the present disclosure.

FIG. 2 is a sectional view of a part-region of a motor vehicle in the longitudinal direction of the vehicle (Y-section), in accordance with the present disclosure.

### DESCRIPTION

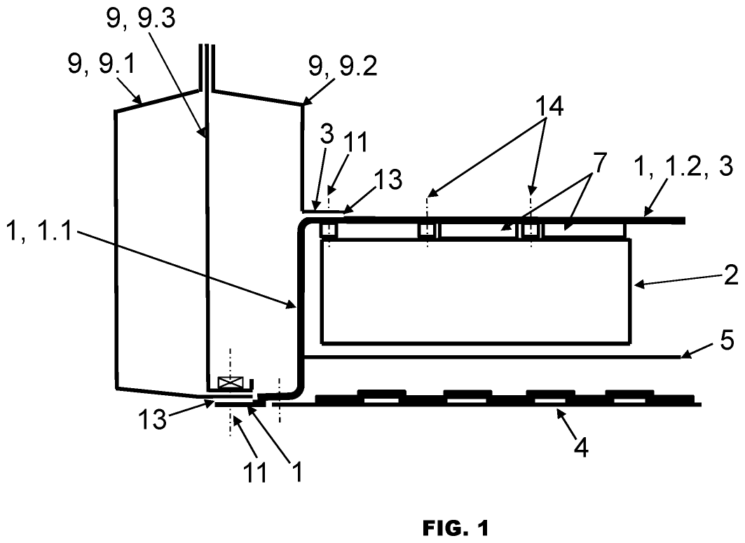

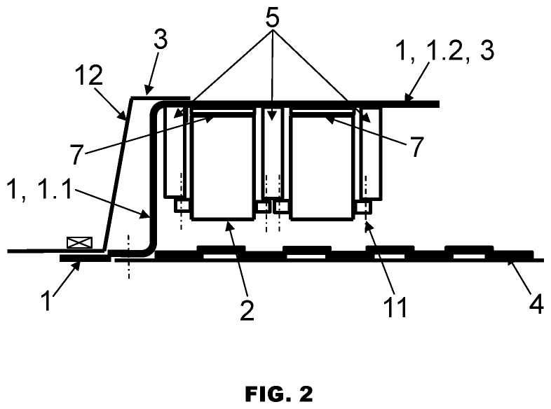

FIG. 1 is a schematic representation of a high-voltage battery in a trough 1 of a motor vehicle in accordance with the present disclosure, in the transverse direction. The vehicle is thus seen from the front. In FIG. 2, the same vehicle is shown in a section normal to the section of FIG. 1, that is to say in the longitudinal direction of the vehicle, seen from the side.

The motor vehicle shown in part comprises a high-voltage battery which comprises a battery housing, wherein the battery housing comprises sidewalls 1.1 and a cover 1.2 which covers the sidewalls 1.1 at the top. The sidewalls 1.1 and the cover 1.2 are formed in one piece by a trough 1 which is open at the bottom.

A plurality of battery cells 2 are arranged in the battery housing, that is to say in the trough 1. The battery cells 2 are mounted “suspended” in the trough 1, so that the electrical contacts of the battery cells 2 are oriented downwards and the cell bases are oriented upwards.

The cover 1.2 of the trough 1 forms a floor panel 3 of the motor vehicle and is fastened at the lateral edges, from beneath, to a further floor panel 3 at the edge, namely screwed via screw connections 11 and additionally adhesively bonded by means of adhesive 13 between the floor panel 3 at the edge and the cover 1.2 of the trough 1. The floor panel 3 at the edge can be formed by the sill 9, in particular by a shell of the inner upper sill 9.2.

The cover 1.2 of the trough 1 has fastening points 14 for seat cross-members. Seat cross-members can be fastened directly to the trough 1, in particular screwed to the cover 1.2.

The trough 1 is fastened, namely mounted from beneath, to a lateral sill 9 of the motor vehicle. The trough 1 is fastened to the sill 9 by means of adhesive 13 and a screw connection 11. Fastening to the sill 9 can take place at a lateral edge of the trough 1, which forms a flange parallel to the road and to the cover 1.2. The trough 1 is shown in FIG. 1 fastened to a shell 9.1 of the sill 9 that forms the outer side of the sill 9. The trough 1 is additionally fastened, as described hereinbefore, to a shell 9.2 of the sill 9, which can be located on the inside and can form an upper part of the sill 9. A lower part of the inner side of the sill 9 can be formed by the sidewalls 1.1 of the trough 1. The sill 9 can additionally have a central reinforcement or shell 9.3. The central shell 9.3 can likewise be fastened to the trough 1.

The trough 1, in particular sidewalls 1.1 of the trough 1, thus form part of the supporting structure of the motor vehicle, namely of the lateral sills 9 of the motor vehicle.

A plurality of cross-members 5 of the supporting structure of the motor vehicle are arranged inside the trough 1 of the high-voltage battery, wherein the cross-members 5 are formed integrally with the trough 1.

As can clearly be seen in FIG. 2, the battery cells 2 are each mounted “suspended” from the cross-members 5 in the gaps between the cross-members 5, so that a plurality of parallel rows of battery cells 2 run between the cross-members 5.

At least one planar cooling element 7 can be arranged on the upper side of the battery cells 2, between the battery cells 2 and the cover 1.2 of the trough 1.

An underride guard plate 4 forms the base of the high-voltage battery which covers the trough 1 on the lower side thereof.

In contrast to conventional designs, in accordance with the present disclosure a battery housing in the form of an inverted trough 1 is installed in a structurally integrated manner into a vehicle body and at the same time closes an underbody from beneath. For joining the trough 1, a mounting adhesive system with adhesive 13 is used, in combination with mechanical joining elements 11, such as screws, rivets, etc. The mechanical joining points 11 allow the vehicles to be manufactured continuously without the vehicle having to be discharged in order for the adhesive 13 to cure.

Accessibility to the battery modules is ensured from beneath via a removable plate 4, which at the same time is designed as an underride guard.

The battery modules 2 are mounted in the housing suspended from cross-members 5. The cross-members 5 form a unit with the battery trough 1.

Pre-assembly of the battery housing takes place in the disassembled state and the housing, namely the trough 1, is accessible from beneath. The cooling plate 7 is first installed and fixed from beneath. There then follow the battery modules 2, which still have to be electrically connected to one another. Lastly, the closing plate 4, which at the same time is designed as an underride guard, is fitted from beneath. For completion of the battery, it can also be turned over in order to simplify installation of the components.

The battery trough 1 can be designed as a one-piece die-cast component (megacasting), in which the cross-members 5 and the seat fastening points 14 are also already integrated. In addition, necessary attachment points for components in the interior can already be present in the cast part.

In an embodiment variant, the cooling elements 7 are inserted and fixed above the cells 2.

A fundamental advantage of this arrangement is the installation space gained in the Y direction by the cross section which a battery frame usually requires, and the integration of a plurality of components and the associated saving in terms of individual parts and joining technology.

The Z-dimensional chain likewise becomes smaller owing to the absence of an air gap between the floor panel and the battery housing.

Costs and weight are further saved as a result of the omission of the battery frame.

### LIST OF REFERENCE SYMBOLS

1 Trough
1.1 Trough side wall
1.2 Trough cover
2 Battery cells
3 Floor panel
4 Underride guard plate
5 Cross-member
7 Cooling element
9 Sill
9.1 Outer sill
9.2 Inner upper sill
9.3 Central sill
11 Screw connection
12 Supporting structure
13 Adhesive
14 Fastening points for seat cross-members

What is claimed is:

1. A motor vehicle, comprising:
a high-voltage battery having:
a battery housing with a trough defined at least by sidewalls and a cover to cover the trough at an upper region of the sidewalls, and
a plurality of battery cells mounted for suspension in the trough such that electrical contacts of the battery cells are oriented downwards and bases of the battery cells are oriented upwards.

2. The motor vehicle of claim 1, wherein the cover forms a floor panel of the motor vehicle.

3. The motor vehicle of claim 1, wherein the cover is fastened to a supporting structure of the motor vehicle.

4. The motor vehicle of claim 1, wherein the trough is fastened to lateral sills of the motor vehicle.

5. The motor vehicle of claim 1, wherein the cover comprises fastening points to facilitate connection to seat cross-members.

6. The motor vehicle of claim 1, wherein the high-voltage battery further has an underride guard plate forming a base to cover the trough at a lower region thereof.

7. The motor vehicle of claim 1, further comprising a plurality of cross-members, forming a supporting structure of the motor vehicle, arranged in the trough.

8. The motor vehicle of claim 7, wherein the cross-members are integrally formed with the sidewalls and/or the cover.

9. The motor vehicle of claim 7, wherein each battery cell in the plurality of battery cells are mounted for suspension from the cross-members in gaps between adjacent cross-members so that a plurality of parallel rows of battery cells extend between the cross-members.

10. The motor vehicle of claim 1, further comprising at least one cooling element arranged between an upper region of the battery cells and the cover.

11. The motor vehicle of claim 1, wherein the sidewalls and the cover are formed in one piece.

12. A high-voltage battery for a motor vehicle, the high-voltage battery comprising:
a battery housing with a trough defined at least by sidewalls and a cover to cover the trough at an upper region of the sidewalls; and
a plurality of battery cells mounted for suspension in the trough such that electrical contacts of the battery cells are oriented downwards and bases of the battery cells are oriented upwards.

13. The high-voltage battery of claim 12, wherein the cover forms a floor panel of the motor vehicle.

14. The high-voltage battery of claim 12, further comprising an underride guard plate forming a base to cover the trough at a lower region thereof.

15. The high-voltage battery of claim 12, wherein each battery cell in the plurality of battery cells are mounted for suspension from cross-members of the motor vehicle in gaps between adjacent cross-members so that a plurality of parallel rows of battery cells extend between the cross-members.

16. The high-voltage battery of claim 12, further comprising at least one cooling element arranged between an upper region of the battery cells and the cover.

17. The high-voltage battery of claim 12, wherein the sidewalls and the cover are formed in one piece.

18. A method for manufacturing a motor vehicle, the method comprising:
fabricating a high-voltage battery having a battery housing with a trough defined at least by sidewalls and a cover to cover the trough at an upper region of the sidewalls; and
mounting a plurality of battery cells for suspension in the trough such that electrical contacts of the battery cells are oriented downwards and bases of the battery cells are oriented upwards,
wherein the trough and cross-members forming a supporting structure of the motor vehicle are fabricated together as a die-cast component so that the cross-members are already integrated in the trough when producing the trough.

19. The method of claim 18, wherein the trough and the cross-members are fabricated via a megacasting process.

20. The method of claim 18, wherein the battery cells are mounted for suspension in the trough via a pre-assembly process, and then the pre-assembled high-voltage battery is mounted from beneath in a supporting structure of the motor vehicle.
